(19) United States
(12) Patent Application Publication
(10) Pub. No.: US 2026/0291569 A1
(43) Pub. Date: Sep. 24, 2026

(54) DMRS-BASED UPLINK DIMENSION REDUCTION IN MASSIVE MIMO RADIO UNIT

(71) Applicant: Telefonaktiebolaget LM Ericsson (publ), Stockholm (SE)

(72) Inventors: Chenguang LU, Sollentuna (SE); Jonas KARLSSON, UPPLANDS VÄSBY (SE); Miguel BERG, SOLLENTUNA (SE); Björn POHLMAN, JÄRFÄLLA (SE); Per EMANUELSSON, LUND (SE)

(73) Assignee: Telefonaktiebolaget LM Ericsson (publ), Stockholm (SE)

(21) Appl. No.: 19/474,868

(22) PCT Filed: Apr. 17, 2024
(86) PCT No.: PCT/SE2024/050374

§ 371 Date: Oct. 13, 2025

Related U.S. Application Data
(60) Provisional application No. 63/459,831, filed on Apr. 17, 2023.

(51) Int. Cl. H04B 7/06; H04L 25/02; H04L 27/26

(52) U.S. Cl. CPC H04B 7/0617; H04L 25/0202; H04L 27/261

(57) ABSTRACT

A network node can obtain demodulation reference signal, DMRS, symbols multiplexed with data symbols in a slot. The network node can further calculate dimension reduction weights based on the DMRS symbols. The network node can further perform dimension reduction based on the dimension reduction weights to produce dimension reduced channel estimates. The network node can further calculate beamforming weights based on the dimension reduced channel estimates. The network node can further form beamformed data symbols based on the beamforming weights and the data symbols.

### TECHNICAL FIELD

The present disclosure relates generally to communications, and more particularly to and more particularly to communication methods and related devices and nodes supporting wireless communications.

### BACKGROUND

Massive multiple input, multiple output (MIMO) techniques have been first adopted to practice in long term evolution (LTE). In 5G, it becomes one key technology component, which will be deployed on a much larger scale than in LTE. It features with a large number of antennas used on the base-station side, where the number of antennas is typically much larger than the number of user-layers, for example, 64 antennas serving 8 or 16 user-layers in frequency range 1 (FR1), which comprises sub-6 GHz frequency bands, and 256/512 antennas serving 2 or 4 layers in frequency range 2 (FR2), which comprises frequency bands from 24.25 GHz to 52.6 GHz. A user layer when used herein e.g., means an independent downlink or uplink data stream intended for one user. One user or UE may have one or multiple user layers. User layer is also referred to as layer, e.g., using 3GPP terminology. Massive MIMO is also referred to as massive beamforming, which is able to form narrow beams focusing on different directions to counteract against the increased path loss at higher frequency bands. It also benefits multi-user MIMO which allows for transmissions from/to multiple users simultaneously over separate spatial channels resolved by the massive MIMO technologies, while keeping high capacity for each user. Therefore, it can significantly increase the spectrum efficiency and cell capacity.

At the base-station side, the interface between the distributed unit (DU) and the radio unit (RU) is the fronthaul interface, as illustrated in FIG. 1. In some examples, the interface between the DU and RU can include additional equipment (e.g., switches or routers). The great benefits of massive MIMO at the air-interface also introduce new challenges at the base-station side. The legacy common public radio interface (CPRI)-type fronthaul transports time-domain IQ samples per antenna branch. As the number of antennas scales up in massive MIMO systems, the required fronthaul capacity also increases proportionally, which significantly drives up the fronthaul costs. To address this challenge, the fronthaul interface evolved from CPRI (Common Public Radio Interface) to eCPRI (enhanced or evolved CPRI). In eCPRI, other functional split options between a DU and a RU are supported, referred to as different lower-layer split (LLS) options. In the eCPRI specification, the terms eREC (eCPRI Radio Equipment Control) and eRE (eCPRI Radio Equipment) are used instead of DU and RU. The basic idea is to move the frequency-domain beamforming function from DU to RU so that frequency-domain IQ samples or data of user-layers are transported over the fronthaul interface. Note that the frequency-domain beamforming is sometimes also referred to as precoding in the downlink (DL) direction and equalizing or pre-equalizing in uplink (UL) direction. By doing this, the required fronthaul capacity and thereby the fronthaul costs are significantly reduced, as the number of user layers is typically much fewer than the number of antennas in massive MIMO. In an open radio access network (O-RAN), DU is referred to as O-DU while RU is referred to as O-RU.

FIG. 2 illustrates the implementation of the uplink (UL) specification of the O-RAN working group 4 (WG4) standard suitable for massive MIMO. By having the beamforming function in the O-RU, the number of streams going through the fronthaul interface becomes smaller than the number of antenna branches. However, the beamforming weights are calculated in the O-DU based on the sounding reference signal (SRS) signal sent back from the O-RU. Since the SRS channel estimates correspond to an earlier channel, the required number of streams is still much larger than the number of layers to avoid performance loss, compared to that using CPRI-based fronthaul. There is a tradeoff between the number of streams used and the performance.

### SUMMARY

According to some embodiments, a method in a network node includes obtaining reference signal, DMRS, symbols multiplexed with data symbols in a slot. The method further includes calculating dimension reduction weights based on the DMRS symbols. The method further includes performing dimension reduction based on the dimension reduction weights to produce dimension reduced channel estimates. The method further includes calculating beamforming weights based on the dimension reduced channel estimates. The method further includes forming beamformed data symbols based on the beamforming weights and the data symbols.

According to other embodiments, a network node, radio unit (RU), system, computer program, computer program product, non-transitory computer readable medium, or host is provide to perform the above method.

Certain embodiments may provide one or more of the following technical advantage(s). Using the DMRS symbols, there is no channel aging issue since the DMRS symbols are multiplexed with data symbols in the same slot. There is no interoperability issue for the multi-vendor case since the RU does the dimension reduction. The RU can be tested on its own since all algorithms are done by the same vendor of the RU.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a fronthaul interface between a RU (radio unit) and a DU (distributed unit);

FIG. 2 is an illustration of a current uplink specification of O-RAN WG4;

FIG. 3 is an illustration of Solution A of improved UL functional division by the O-RAN WG4;

FIG. 4 is an illustration of Solution B of improved UL functional division by the O-RAN WG4;

FIG. 5 is an illustration of SRS-based dimension reduction for Solution A of FIG. 3;

FIG. 6 is an illustration of SRS-based dimension reduction for Solution B of FIG. 4;

FIG. 7 is an illustration of DMRS-based dimension reduction for Solution A according to some embodiments;

FIG. 8 is an illustration of DMRS-based dimension reduction for Solution B according to some embodiments;

FIG. 9 is an illustration of a first embodiment of DMRS-based dimension reduction according to some embodiments;

FIG. 10 is an illustration of an example of a 1+1 DMRS configuration (1 DMRS in front and 1 DMRS in back);

FIG. 11 is an illustration of a second embodiment of DMRS-based dimension reduction according to some embodiments;

FIG. 12 is an illustration of an alternate embodiment of the second embodiment of DMRS-based reduction according to some embodiments;

FIG. 13 is an illustration of a third embodiment of DMRS-based dimension reduction according to some embodiments;

FIGS. 14-15 are flow chart illustrating operations of a network node according to some embodiments;

FIG. 16 is a block diagram of a communication system in accordance with some embodiments;

FIG. 17 is a block diagram of a user equipment in accordance with some embodiments;

FIG. 18 is a block diagram of a network node in accordance with some embodiments;

FIG. 19 is a block diagram of a host computer communicating with a user equipment in accordance with some embodiments;

FIG. 20 is a block diagram of a virtualization environment in accordance with some embodiments; and

FIG. 21 is a block diagram of a host computer communicating via a base station with a user equipment over a partially wireless connection in accordance with some embodiments.

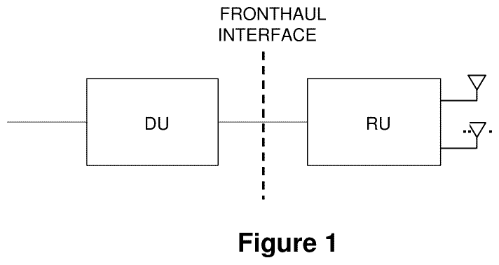

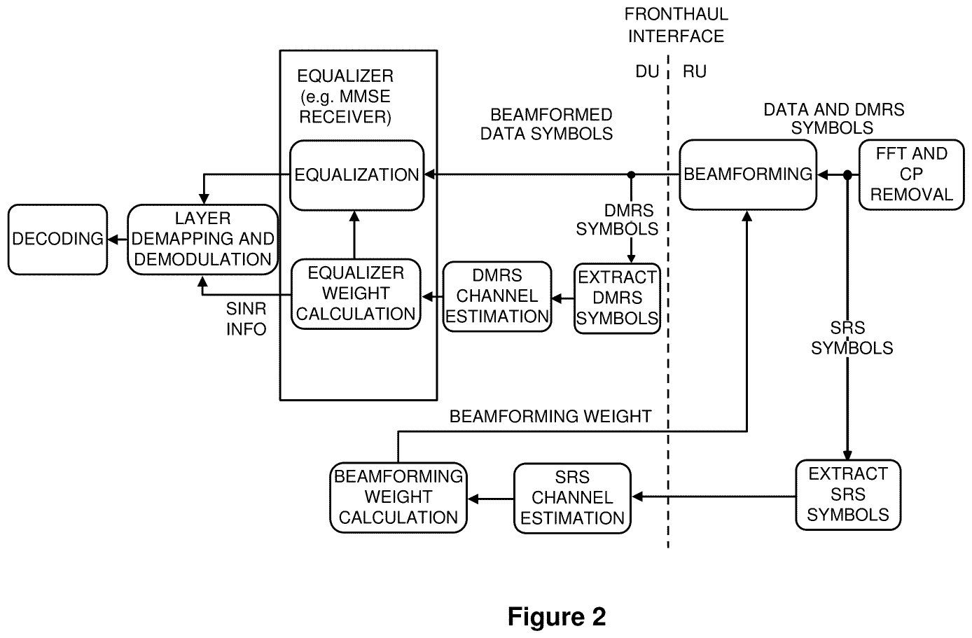

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

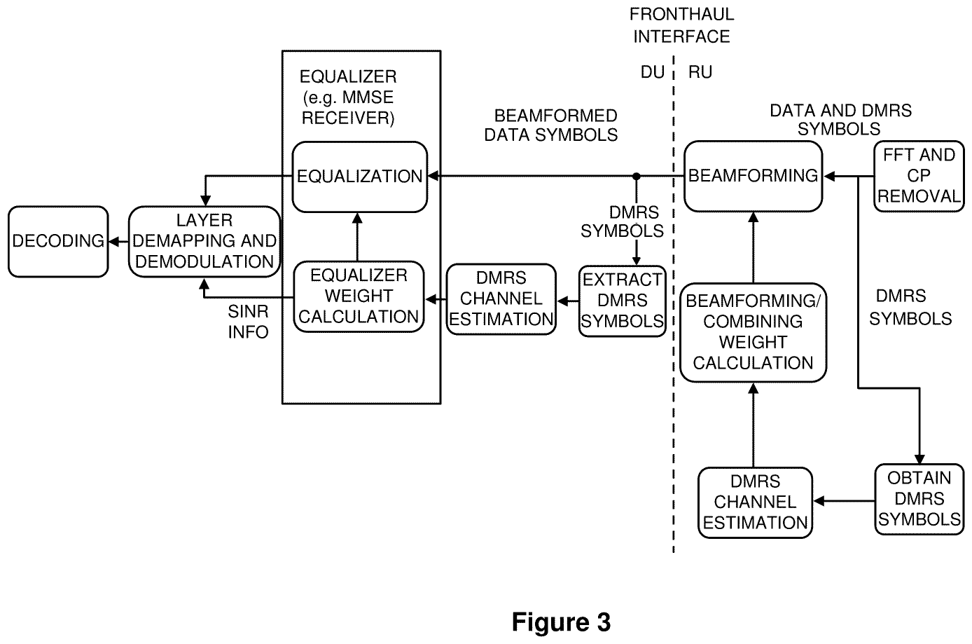

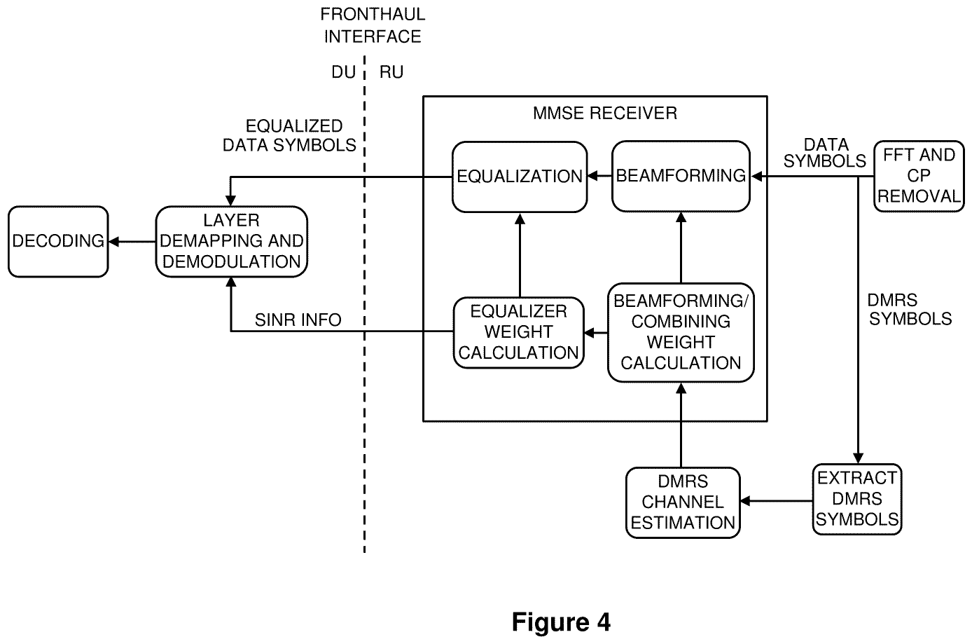

O-RAN WG4 is currently investigating improving the current specification by introducing new UL functional divisions to achieve the best performance using the minimum fronthaul bit rate, i.e., reducing the number of streams to the number of layers. There are two solutions proposed to achieve such improvement. Solution A is shown in FIG. 3. Solution B is shown in FIG. 4.

Both solutions move the demodulation reference signal (DMRS) channel estimation and beamforming weight calculation to O-RU. One difference is that Solution B does equalization (i.e., includes an equalizer) in O-RU while Solution A does equalization in O-DU and the O-RU of Solution A doesn't do equalization. The second difference is that Solution B does not send DMRS from O-RU to O-DU while Solution A does. Instead, Solution B sends the signal to interference and noise ratio (SINR) information from O-RU to O-DU to assist O-DU to demodulate the equalized symbols. The SINR information represents the measured/estimated SINR values, e.g., per physical resource block (PRB) per layer, which is used by the demodulator for demodulation of the symbols of each subcarrier per layer, e.g., the demodulation algorithm based on LLR (log likelihood ratio). The equalized symbols are often referred to as soft values in demodulation terminology. The third difference is that Solution A does a second channel estimation in O-DU to calculate the equalization weights in O-DU while Solution B directly uses the SINR information received to demodulate the equalized symbols and thereby doesn't need to do channel estimation again in O-DU. In FIG. 4, it is noted that the beamforming weight calculation block also passes the channel estimates to the equalizer weight calculation block. The equalization weight calculation block can use the channel estimates to calculate the equalization weights, without the knowledge of the beamforming weights. But it is sometimes more computational efficient to reuse the beamforming weights in the equalizer weight calculation. Further, in FIG. 3, equalization and beamforming are presented by two separate functional blocks for Solution B. This illustration is mainly to show the difference of Solution A and Solution B. An alternative implementation is to combine equalization and beamforming as one functional block, e.g., a beamforming block which performs equalization as well. This implementation is more computational efficient since the data symbols only needed to be beamformed (processed) once.

In wireless communication, an equalizer performs an equalization operation on the input signal, which reverses the distortion caused by the end-to-end channel including the transmitter chain, the over-the-air channel (including the wanted channel and the interference channel), and the receiver chain. After the equalization, the equalized signal can be demodulated by a demodulator. When the input signal is from multiple transmitters which send different data, the equalizer may also mitigate the interferences between them. Equalizers can be linear or non-linear. Examples of linear equalizers are zeroforcing equalizer, MMSE equalizer etc. Examples of non-linear equalizers are decision-feedback equalizer etc.

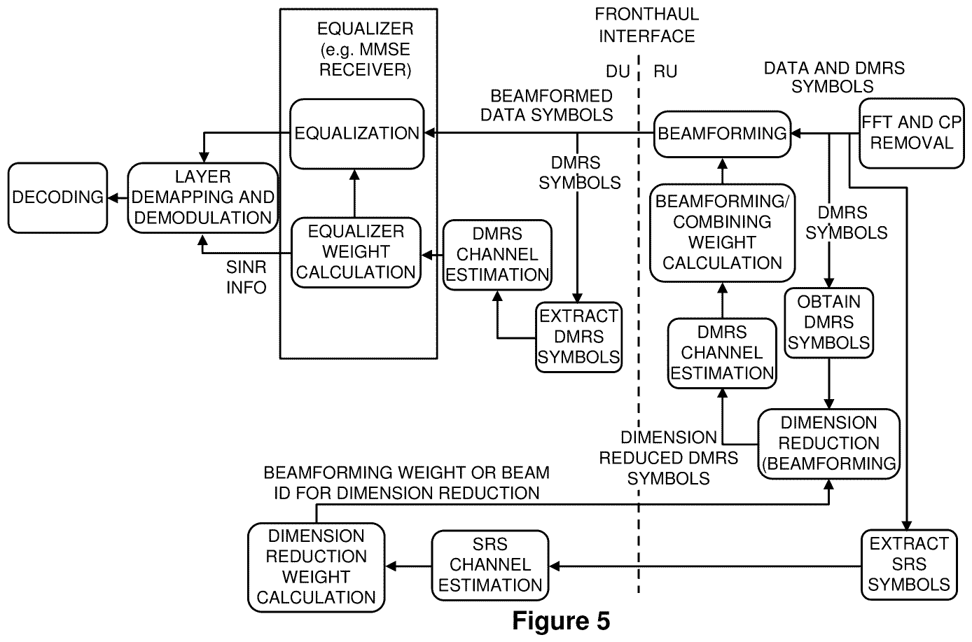

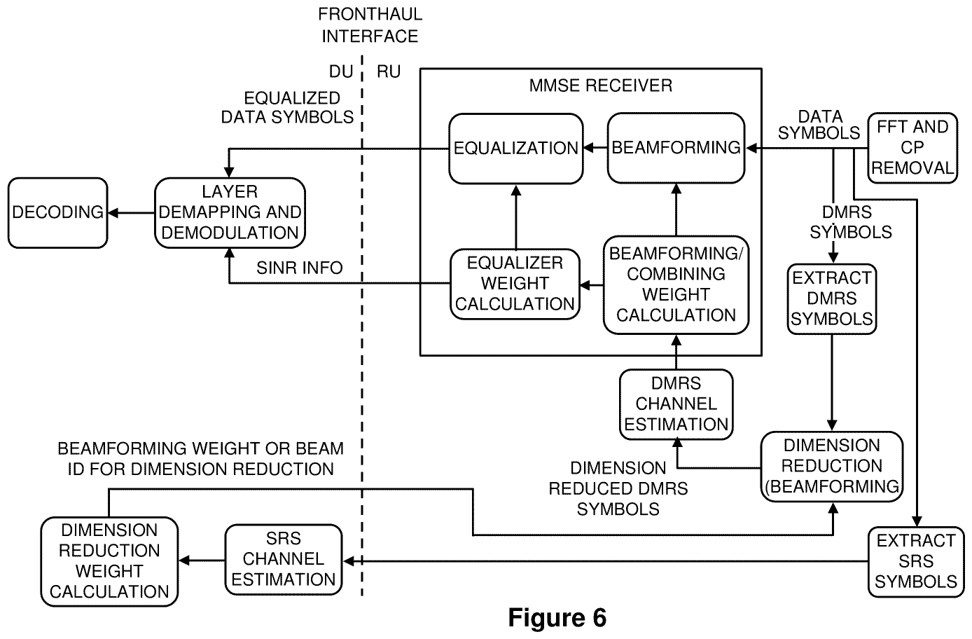

There currently exist certain challenge(s). Both Solution A and B increase the RU complexity by moving DMRS channel estimation and beamforming weight calculation (Solution B also includes equalization weight calculation) to the RU. There are some concerns regarding the RU complexity increase compared with the implementation of the current UL specification of O-RAN WG4. To address this, one proposal has been proposed to reduce the RU complexity, as shown in FIG. 5 and FIG. 6 for Solution A and B, respectively. The basic idea is to reduce the spatial dimension of the UL channel to be estimated, based on the SRS channel estimation in the DU. The original spatial dimension of the channel between user equipments (UEs) and an RU is N×K where N represents the number of antennas (or antenna ports) of the RU and K represents the number of layers of the transmissions from all UEs. The idea is to reduce the channel dimension by performing a beamforming operation for DMRS symbols. Before dimension reduction, there are N sets of DMRS symbols, each of which are received from one antenna (or antenna port). After the beamforming (dimension reduction), it is reduced to R sets of DMRS symbols, where R<N. The dimension of the effective channel after dimension reduction is reduced to R×K. Then, the DMRS channel estimation will estimate a channel with reduced dimension. Therefore, the channel estimation complexity is reduced. The beamforming weight and equalizer weight calculation are also based on the channel estimates with reduced dimension. Therefore, the weight calculation complexity is also reduced.

The dimension reduction approach described above is based on the channel estimates using SRS (sounding reference signal). The DU receives the SRS signals from the RU and performs the channel estimation using the received SRS signal. Then, the DU calculates the dimension reduction weights based on the SRS channel estimates and send the weights to the RU, which will use the received weights to perform dimension reduction. In another alternative, the SRS channel estimation may be done in the RU. In this case, the RU sends back the channel estimates and then DU will calculate the dimension reduction weights based on the received channel estimates from RU. Note that DU only needs to send beam IDs (i.e., beam indices) if the beamforming weight definition is predefined, e.g., based on the beams generated with DFT (discrete Fourier transform) basis vectors.

There currently exist certain challenge(s). One problem is that the dimension reduction weights are based on the aged channel estimates from SRS which represents an earlier channel. The mismatch between the channel estimate of the aged channel and the current channel will affect the dimension reduction performance, especially for users with high mobility and/or in scenarios where intercell interference varies significantly from slot to slot. It would limit the reduction in dimension. To avoid performance degradation, larger channel dimension needs to be kept, which would limit the reduction of computation complexity.

Another problem is that it may cause an interoperability issue if DU and RU are from different vendors. In this case, the RU does not know the dimension reduction algorithm used by the DU. For example, it is impossible for the RU to optimize its channel estimation algorithm in the product design phase if it doesn't know how dimension reduction is done. So, the RU channel estimation algorithm may not perform optimally and therefore the performance is degraded. Also, it is very difficult to define test cases since normally vendors will not disclose the details of their algorithms.

Certain aspects of the disclosure and their embodiments may provide solutions to these or other challenges. A dimension reduction approach based on DMRS is provided. The dimension reduction weights are determined by the RU itself. The weight calculation can be based on the DMRS channel estimates. It can also be based on other metrics calculated using DMRS symbols, e.g., the total power of the DMRS symbols with pre-defined beams.

Throughout the description herein and the figures therein, a MMSE (minimum mean-squared error) receiver algorithm is given as an example. In practice, the concepts described herein are not limited to the MMSE receiver or the equalization algorithms exemplified.

The dimension reduction operation for DMRS (i.e., the dimension reduction block in the diagrams) is explicitly presented and described, while the dimension reduction for PUSCH (physical uplink shared channel) data symbols is implicitly included in the beamforming operation (i.e., the beamforming block in the diagrams). Another alternative is to have an explicit dimension reduction block for data symbols before the beamforming block. But this implementation is less efficient than the case where the dimension reduction is implicitly done in the beamforming because more multiplication operations (i.e., requiring more computational resources) are needed if an explicit dimension reduction is done for data symbols first before performing beamforming.

Mathematically, the equalized symbols after beamforming and equalization can be expressed as

$$\hat{x} = WHx + Wn$$

where x is a K×1 vector representing the transmitted symbols of K layers (assuming each layer is transmitted from one antenna of a UE, K layers can be from one UE or multiple UEs), H is a N×K matrix representing the channel between UE(s) and the RU, W is a K×N matrix representing the operations of the beamforming and equalization, and n is a N×1 vector representing the interferences and noise at the receiver. Then, the equalized symbols are fed to the demodulator for demodulation.

An MMSE equalizer (including beamforming) W can be expressed as

$$W = {( {H}^{H} {Q}^{- 1} H + I )}^{- 1} {H}^{H} {Q}^{- 1}$$

where Q=E(nn^{H}) is a N×N matrix representing the covariance matrix of the interference and noise and A^{H} represents the conjugate transpose of a matrix or vector A. Both H and Q are obtained by DMRS channel estimation. From the above equation, the computational complexity scales with N and K. Since N is much larger than K in massive MIMO, the complexity is dominated by N. Especially, the inverse of a large N×N matrix of Q is quite computational complex. The number of mathematical operations for calculating Q⁻¹ scales with N in the order of N³. It means reduction of N to half means computational complexity reduction to ⅛ in calculation of Q⁻¹. Further, reduction of N also reduces the number of mathematical operations for matrix multiplications, e.g., in H^{H}Q⁻¹, H^{H}Q⁻¹H, etc.

Basically, the purpose of dimension reduction is to reduce the value of N by performing another beamforming before the equalization W. With dimension reduction, the equalized signal after beamforming and equalization (i.e., W) can be expressed as

$$\begin{matrix}\hat{x} = W {W}_{R} H x + W {W}_{R} n \\ = {WH}_{R} x + W {n}_{R}\end{matrix}$$

where W_{R} is a R×N matrix (R<N) representing the operation of dimension reduction, H_{R}=W_{R}H is a R×K matrix representing the effective channel after the dimension reduction and n_{R}=W_{R}n is a R×1 vector representing the interferences and noise after the dimension reduction. In this way, the channel dimension is reduced. In this disclosure, W_{R} is referred to as dimension reduction weights.

Then, the MMSE equalizer (including beamforming) W after dimension reduction can be expressed as

$$W = {( {H}_{R}^{H} {Q}_{R}^{- 1} {H}_{R} + I )}^{- 1} {H}_{R}^{H} {Q}_{R}^{- 1}$$

where

$${Q}_{R} = E ( {n}_{R} {n}_{R}^{H} ) = {W}_{R} Q {W}_{R}^{H}$$

is a R×R matrix representing the covariance matrix of the interference and noise after dimension reduction. From the above equation, it is easy to see that the computational complexity of calculating W is reduced because the dimension of all matrices in the equation is reduced.

To give an example for an MMSE receiver implementation illustrated in FIG. 5 (equalization in the DU) and FIG. 6 (equalization in the RU), the beamforming weights in the beamforming block can be expressed as

$${H}_{R}^{H} {Q}_{R}^{- 1} {W}_{R} ,$$

including both the dimension reduction weights W_{R} and the beamforming weights calculated from the reduced channel, while the equalizer weights in the equalization block can be expressed as

$${( {H}_{R}^{H} {Q}_{R}^{- 1} {H}_{R} + I )}^{- 1} .$$

And the DMRS channel estimation block estimates H_{R} and Q_{R}.

The dimension reduction approach described above is based on the channel estimates using SRS (sounding reference signal). Instead of using the SRS, the various embodiments described herein use a dimension reduction approach based on DMRS. The dimension reduction weights are determined by the RU itself. The weight calculation can be based on the DMRS channel estimates. It can also be based on other metrics calculated using DMRS symbols, e.g., the total power of the DMRS symbols with pre-defined beams.

Using the DMRS symbols, there is no channel aging issue since the DMRS symbols are multiplexed with data symbols in the same slot. There is also no interoperability issue for the multi-vendor case since the RU does the dimension reduction.

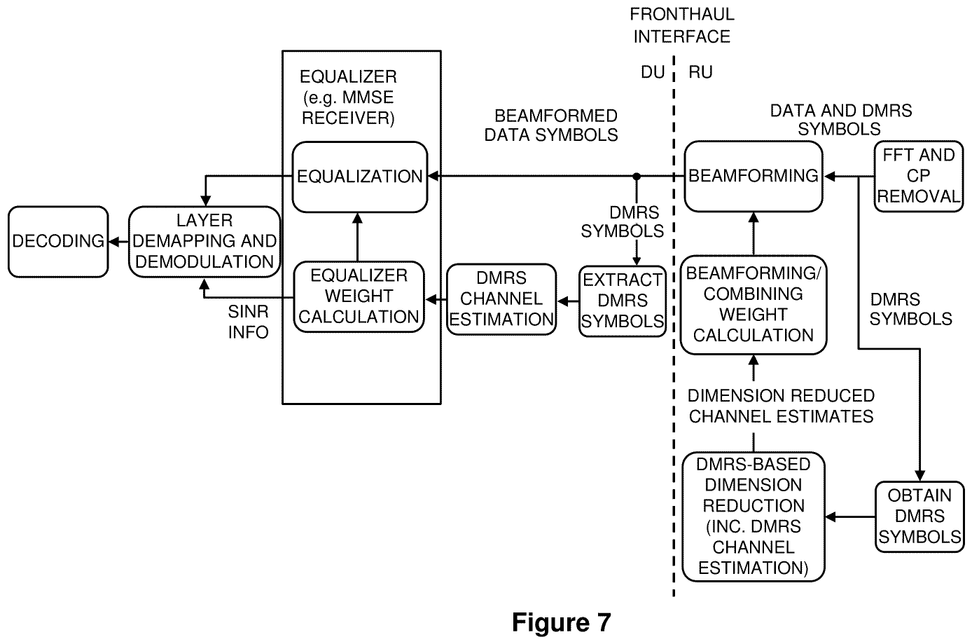

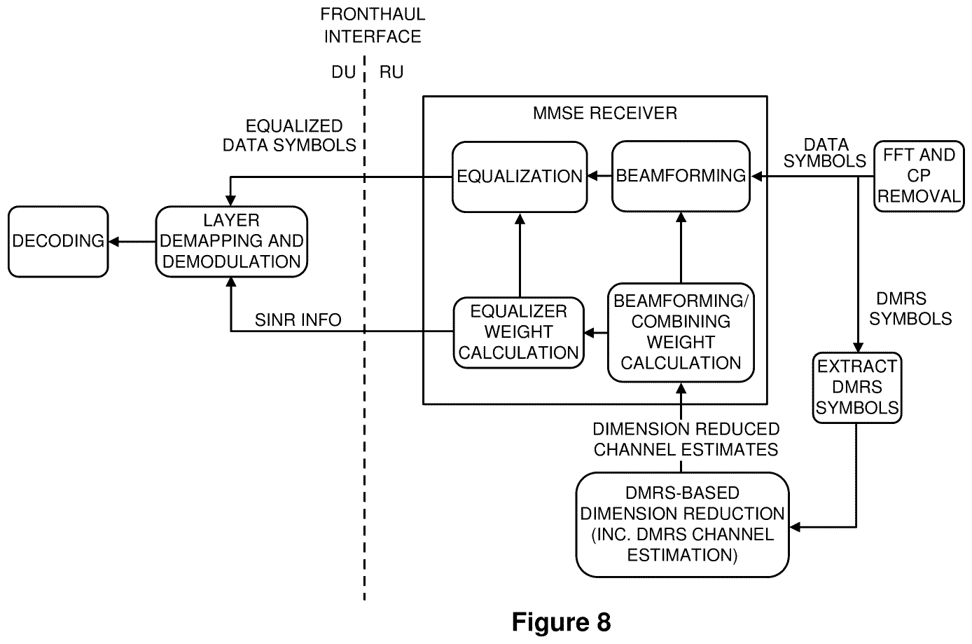

FIG. 7 and FIG. 8 illustrate the DMRS-based dimension reduction approach for Solution A and B of the improved UL functional division, respectively. The RU obtains or extracts the DMRS symbol. Then, the RU performs the dimension reduction using the obtained DMRS symbols and perform channel estimation which produces dimension reduced channel estimates. The dimension reduced channel estimates are used to calculate the beamforming weights (for Solution A and B) and the equalizer weights (for Solution B).

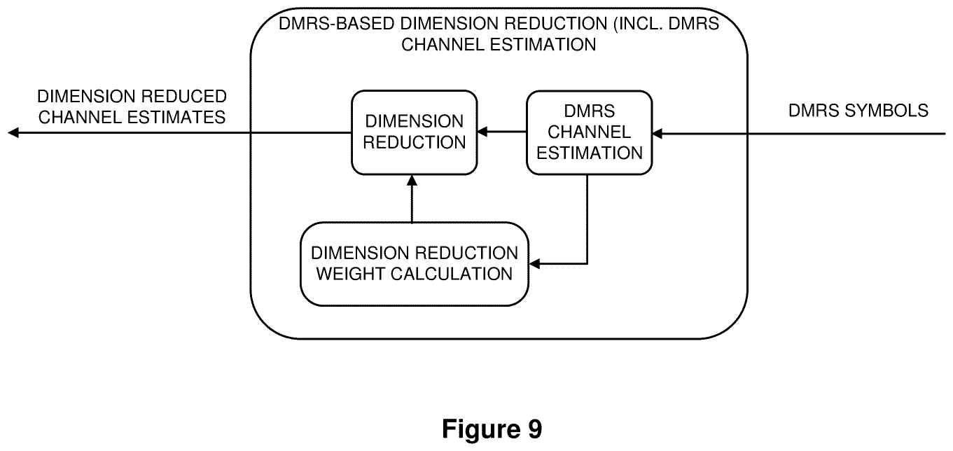

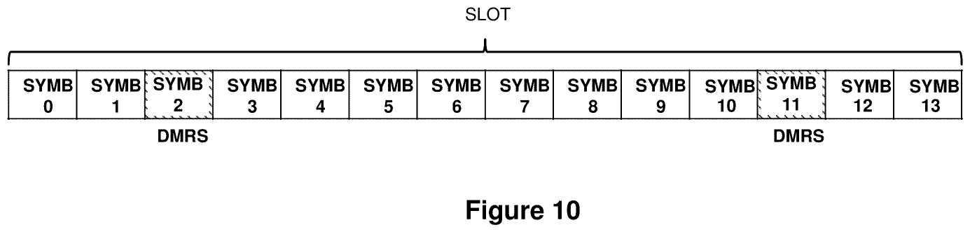

Various embodiments of DMRS-based dimension reduction shall now be described. In the first embodiment illustrated in FIG. 9, channel estimation is first performed using the received DMRS symbols. Then, the channel estimates, H and Q, are used to calculate the dimension reduction weights, W_{R}. The dimension reduction weights W_{R} are applied on the channel estimates and get the dimension reduced channel estimates,

$${H}_{R} = {W}_{R} H and {Q}_{R} = E ( {n}_{R} {n}_{R}^{H} ) = {W}_{R} Q {W}_{R}^{H} .$$

There are DMRS configurations with multiple DMRS symbols used in each slot. Error! Reference source not found. shows an example with two DMRS symbols in one slot. This configuration is usually referred to as 1+1 DMRS. In this example, the first DMRS is at symbol 2 and the second DMRS is at symbol 11. Two DMRS channel estimations will be performed using each DMRS symbols. The calculation of the dimension reduction weight can be based on the channel estimates of the first channel estimation using the first DMRS symbol, the channel estimates of the later channel estimation using the later DMRS symbol, or both. Using the first channel estimation can achieve better latency.

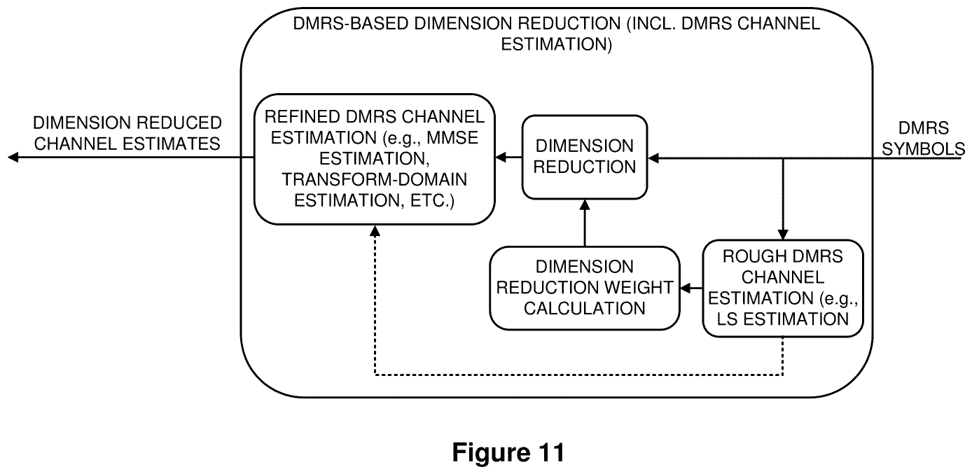

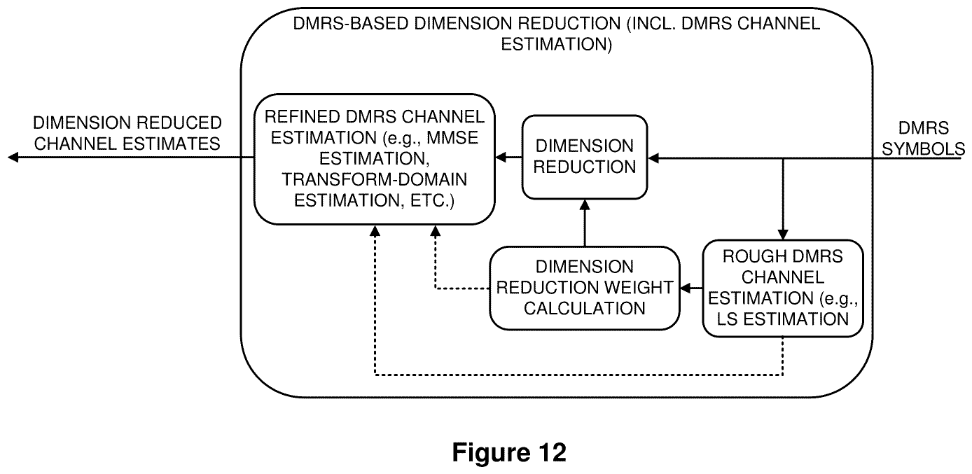

In a second embodiment illustrated in FIG. 11, the RU performs first a rough DMRS channel estimation, e.g., using LS (least-square) channel estimation. The LS channel estimation is a simple estimation method by performing a cross-correlation between the received DMRS symbols and the original DMRS symbols. This operation is much less computational complex than that of the MMSE channel estimation. Therefore, the computation complexity is reduced compared to the first embodiment. The channel estimates of the rough DMRS channel estimation are less accurate than using more advanced channel estimation scheme like MMSE channel estimation, transform-domain estimation, etc. But it is sufficient for the purpose of dimension reduction. Then, the rough channel estimates are used to calculate the dimension reduction weights. The weights are applied to the DMRS symbols. After the dimension reduction, more advanced channel estimation is performed to estimate more accurately H_{R} and Q_{R} from the dimension reduced DMRS symbols. In some implementations as illustrated in FIG. 12, the channel estimation can use the LS estimates to get refined channel estimates H_{R}. In these implementations, they can first apply the dimension reduction weights to the LS estimates to get the LS estimates of the reduced channel. Then, the reduced LS estimates are used to get more accurate channel estimates of H_{R}. After this, the covariance of interference and noise after dimension reduction, Q_{R}, is calculated based on the dimension reduced DMRS and the channel estimates of H_{R}.

As previously described, for DMRS configurations with multiple DMRS symbols in each slot, the calculation of the dimension reduction weights can be based on the channel estimates of the first channel estimation using the first DMRS symbol, the channel estimates of the later channel estimation using the later DMRS symbol, or both. Using the first channel estimation can achieve better latency.

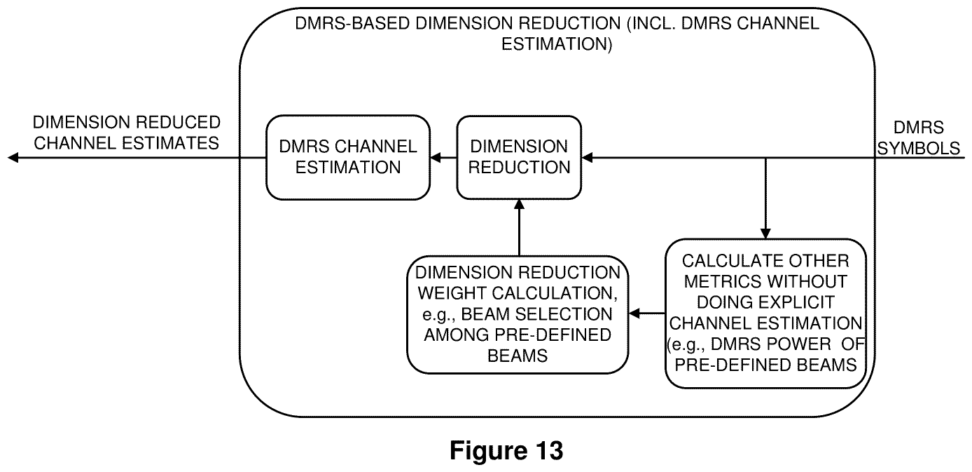

In the first and second embodiments, the dimension reduction weights are calculated based on DMRS channel estimates, accurate or rough. In a third embodiment, illustrated in FIG. 13, other possibilities to determine the dimension reduction weights without performing explicit channel estimation is used. For example, the power of the received DMRS symbols can be calculated. With pre-defined beamforming weights (e.g., based on DFT basis vectors), one can calculate the DMRS power of each beam from the pre-defined beamforming weights. For dimension reduction, a certain number of pre-defined beams can be selected based on the DMRS power, e.g., selecting the beams with the highest DMRS power. Then, the determined dimension reduction weights are applied on the DMRS symbols to obtain the dimension reduced DMRS symbols. Channel estimation is performed on the dimension reduced DMRS symbols to obtain the dimension reduced channel estimates.

It should be noted that the specific algorithms used in calculating the dimension reduction weights are out of the scope of this disclosure. However, to give some examples: the dimension reduction can be based on channel power of pre-defined beams. It can be based on the channel power of the eigen channels by performing SVD (singular value decomposition) or EVD (eigen value decomposition) of the channel covariance.

For dimension reduction based on symbol power, in addition to DMRS symbols, the PUSCH data symbols and other reference symbols (e.g., PTRS (Phase-Tracking Reference Signals) symbols) can also be used for power calculations.

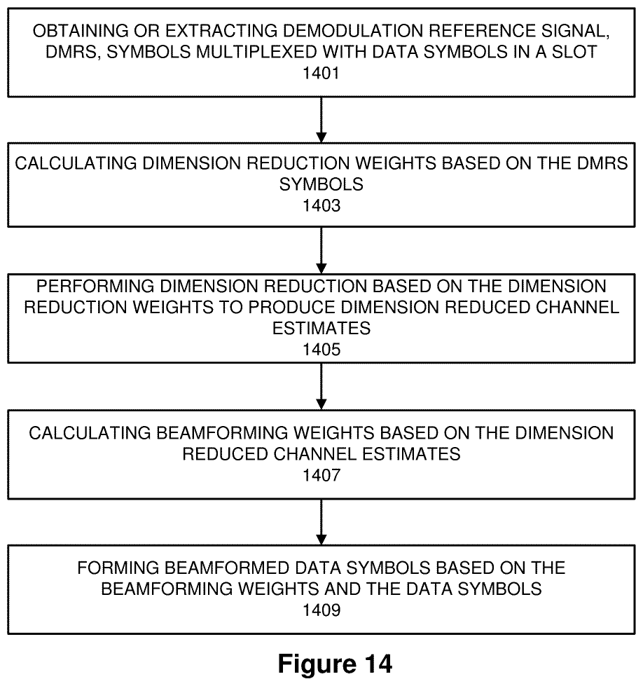

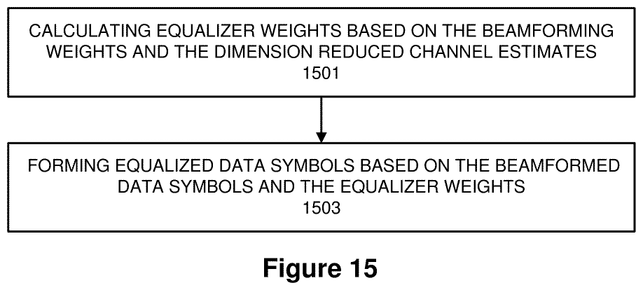

Operations of the network node 1800 (implemented using the structure of FIG. 18) to implement the above embodiments will now be discussed with reference to the flow chart of FIGS. 14-15 according to some embodiments of inventive concepts. For example, modules may be stored in memory 1804 of FIG. 18, and these modules may provide instructions so that when the instructions of a module are executed by respective network node processing circuitry 1802, network node 1800 performs respective operations of the flow chart.

Turning now to FIG. 14, in block 1401, the network node 1800 obtains or extracts demodulation reference signal, DMRS, symbols multiplexed with data symbols in a slot. For example, when the various embodiments are implemented in a DMRS-based dimension reduction approach for Solution A, the network node 1800 obtains the DMRS symbols. In A DMRS-based reduction approach for Solution B, network node 1800 extracts the SMRS symbols. In some of these embodiments, there may be multiple DMRS symbols in the slot. In these embodiments, the network node 1800 performs the dimension reduction based on the DMRS symbols using a first DMRS symbol in the slot. This is done to, e.g., improve latency as compared to using other DMRS symbols in the slot.

In block 1403, network node 1800 calculates dimension reduction weights based on the DMRS symbols. For example, in some embodiments, the network node 1800 calculates dimension reduction weights based on the DMRS symbols by performing channel estimation on the DMRS symbols obtained or extracted. In some of these embodiments, the network node 1800 performs channel estimation by first performing a rough DMRS channel estimation, wherein the rough DMRS channel estimation produces channel estimates which are not sufficiently accurate to be used for calculating beamforming and equalizer weights. In some embodiments, the rough DMRS channel estimate is based on a least-square channel estimation.

In other embodiments, the network node 1800 calculates dimension reduction weights based on the DMRS symbols by calculating other metrics based on the DMRS symbols without explicit channel estimation. For example, the other metric may be power of the DMRS symbols received. In some of these embodiments, the beams with the highest DMRS power are selected.

In block 1405, the network node 1800 performs dimension reduction based on the dimension reduction weights to produce dimension reduced channel estimates. How the calculation of the dimension reduction weights is done is configurable by a network vendor of the RU. In the embodiments where the rough DMRS channel estimate is performed, the network node 1800 performs a refined DMRS channel estimation after applying the dimension reduction weights, which produces dimension reduced channel estimates that are used for calculating beamforming and equalizer weights.

In block 1407, the network node 1800 calculates beamforming weights based on the dimension reduced channel estimates. In block 1409, the network node 1800 forms beamformed data symbols based on the beamforming weights and the data symbols.

In the DMRS-based dimension reduction approach for Solution B, the equalizer weight calculation and equalization are performed on the RU side. In this approach, the network node 1800 performs the operations illustrated in FIG. 15. Turning to FIG. 15, in block 1501, the network node 1800 calculates equalizer weights based on the beamforming weights and the dimension reduced channel estimates. In block 1503, the network node 1800 forms equalized data symbols based on the beamformed data symbols and the equalizer weights.

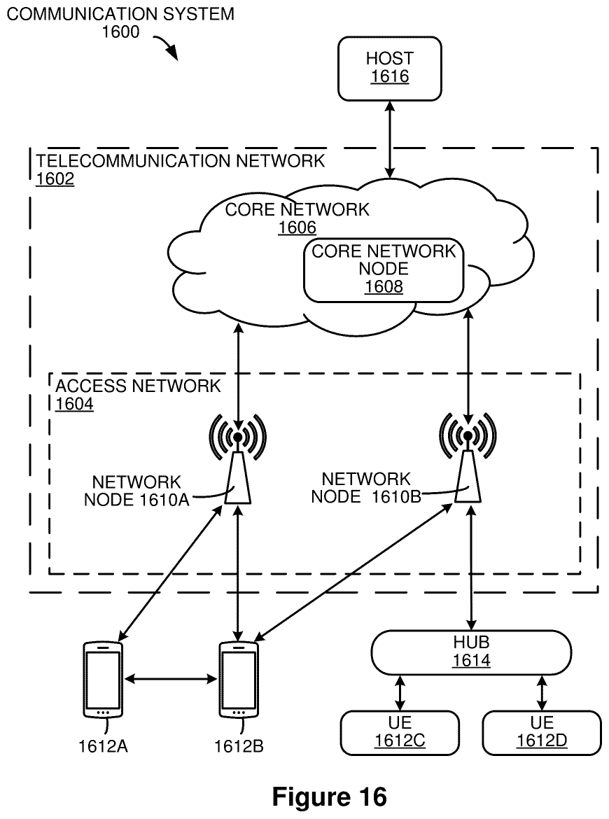

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610A and 1610B (one or more of which may be generally referred to as network nodes 1610), or any other similar 3^{rd} Generation Partnership Project (3GPP) access node or non-3GPP access point. The network nodes 1610 facilitate direct or indirect connection of user equipment (UE), such as by connecting UEs 1612A, 1612B, 1612C, and 1612D (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602 and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi (Light Fidelity), and/or any low-power wide-area network (LPWAN) standards such as LoRa (Long Range) and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT (Internet of Things) services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612C and/or 1612D) and network nodes (e.g., network node 1610B). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular if one or more of the UEs are low energy IoT devices.

The hub 1614 may have a constant/persistent or intermittent connection to the network node 1610B. The hub 1614 may also allow for a different communication scheme and/or schedule between the hub 1614 and UEs (e.g., UE 1612C and/or 1612D), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610B. In other embodiments, the hub 1614 may be a non-dedicated hub—that is, a device which is capable of operating to route communications between the UEs and network node 1610B, but which is additionally capable of operating as a communication start and/or end point for certain data channels.

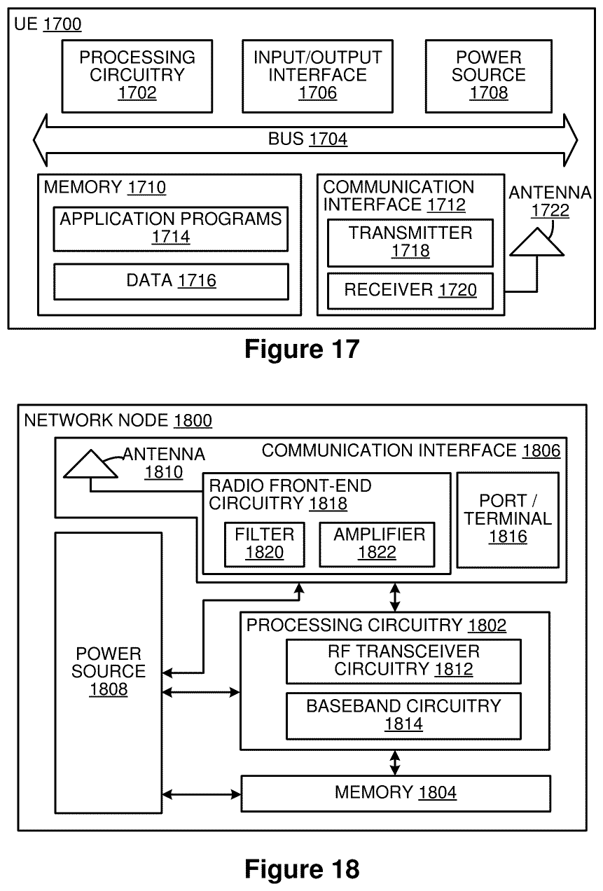

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements and transmit the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

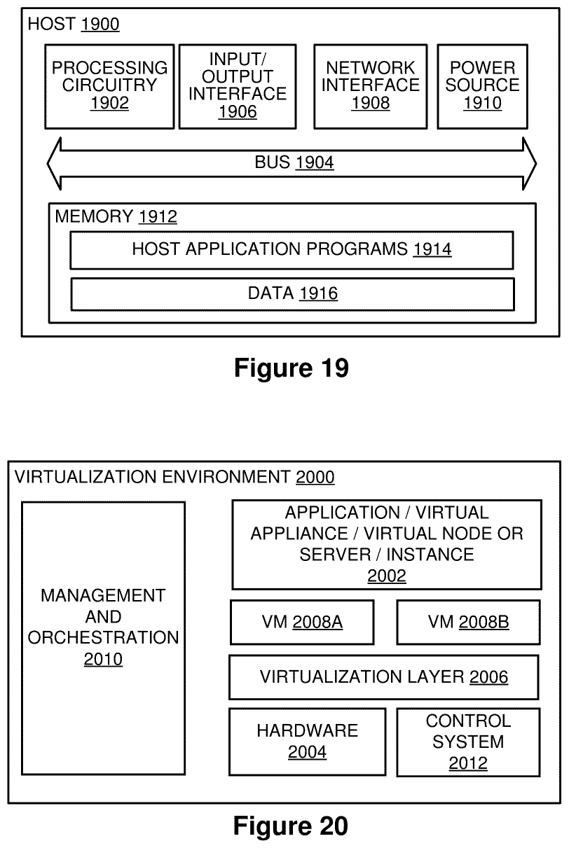

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment 2000 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008A and 2008B (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g., such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

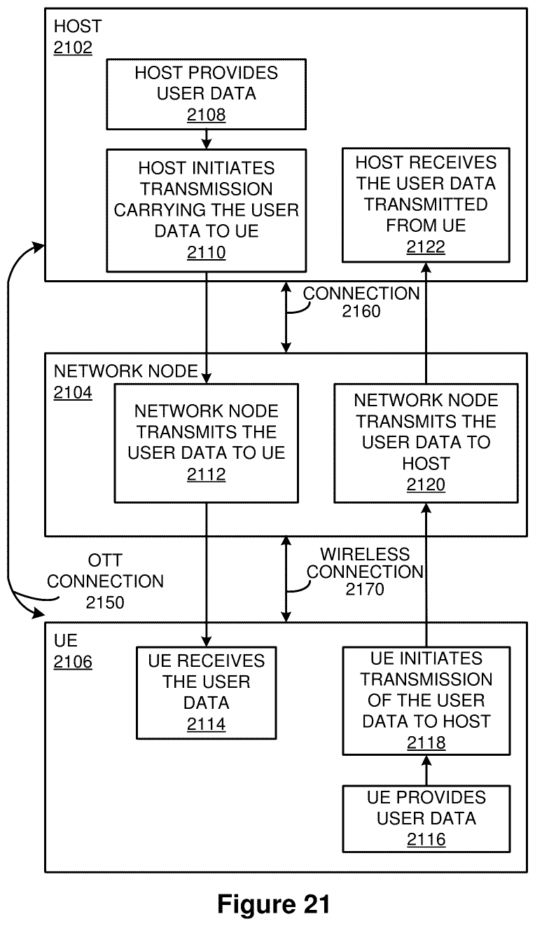

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612A of FIG. 16 and/or UE 1700 of FIG. 17), network node (such as network node 1610A of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

1. A method of operating a network node comprising:
obtaining demodulation reference signal, DMRS, symbols multiplexed with data symbols in a slot;
calculating dimension reduction weights based on the DMRS symbols;
performing dimension reduction based on the dimension reduction weights to produce dimension reduced channel estimates;
calculating beamforming weights based on the dimension reduced channel estimates; and
forming beamformed data symbols based on the beamforming weights and the data symbols.

2. The method of claim 1, wherein the network node is a radio unit, RU,
the method further comprising:
transmitting the beamformed data symbols to a distributed unit, DU.

3. The method of claim 2, wherein forming the beamformed data symbols comprises forming the beamformed data symbols and beamformed DMRS symbols, and
wherein transmitting the beamformed data symbols comprises transmitting the beamformed data symbols and the beamformed DMRS symbols.

4. The method of claim 1, wherein calculating dimension reduction weights based on the DMRS symbols comprises performing channel estimation on the DMRS symbols.

5. The method of claim 4, wherein calculating dimension reduction weights based on the DMRS symbols comprises performing a rough DMRS channel estimation, and
wherein the rough DMRS channel estimation produces channel estimates which are not sufficiently accurate to be used for calculating beamforming and equalizer weights.

6. The method of claim 4, wherein performing the rough DMRS channel estimate comprises performing the rough DMRS based on a least-square channel estimation.

7. The method of claim 5, further comprising:
performing a refined DMRS channel estimation after applying the dimension reduction weights, which produces dimension reduced channel estimates that are used for calculating beamforming and equalizer weights.

8. The method of claim 1, wherein calculating dimension reduction weights based on the DMRS symbols comprises calculating other metrics based on the DMRS symbols without explicit channel estimation.

9. The method of claim 8, wherein the other metric comprises power of the DMRS symbols obtained,
the method further comprising:
selecting beams with a highest DMRS power.

10. The method of claim 1, further comprising:
calculating equalizer weights based on the beamforming weights and the dimension reduced channel estimates; and
forming equalized data symbols based on the beamformed data symbols and the equalizer weights.

11. The method of claim 1, wherein calculating the beamforming weights comprises calculating the equalizer weights, and
wherein forming the beamformed data symbols comprises forming the beamformed data symbols based on the data symbols and the equalizer weights.

12. The method of claim 1, further comprising:
responsive to there being multiple DMRS symbols in the slot, calculating the dimension reduction weights based on the DMRS symbols using a first DMRS symbol in the slot.

13. (canceled)

14. (canceled)

15. (canceled)

16. (canceled)

17. A computer program product comprising a non-transitory storage medium including program code to be executed by processing circuitry (1802) of a network node, whereby execution of the program code causes the network node to perform operations comprising:
obtaining demodulation reference signal, DMRS, symbols multiplexed with data symbols in a slot;
calculating dimension reduction weights based on the DMRS symbols;
performing dimension reduction based on the dimension reduction weights to produce dimension reduced channel estimates;
calculating beamforming weights based on the dimension reduced channel estimates; and
forming beamformed data symbols based on the beamforming weights and the data symbols.

18. The computer program of claim 17, wherein the operations for the forming the beamformed data symbols comprises forming the beamformed data symbols and beamformed DMRS symbols, and wherein the operations for the transmitting the beamformed data symbols comprises transmitting the beamformed data symbols and the beamformed DMRS symbols.

19. A network node comprising:
processing circuitry; and
memory coupled with the processing circuitry, wherein the memory includes instructions that when executed by the processing circuitry causes the network node to perform operations comprising:
obtaining demodulation reference signal, DMRS, symbols multiplexed with data symbols in a slot;
calculating dimension reduction weights based on the DMRS symbols;
performing dimension reduction based on the dimension reduction weights to produce dimension reduced channel estimates;
calculating beamforming weights based on the dimension reduced channel estimates; and
forming beamformed data symbols based on the beamforming weights and the data symbols.

20. The network node of claim 19, wherein the operations for the forming the beamformed data symbols comprises forming the beamformed data symbols and beamformed DMRS symbols, and wherein the operations for the transmitting the beamformed data symbols comprises transmitting the beamformed data symbols and the beamformed DMRS symbols.

21. (canceled)

22. (canceled)
